(19) United States
(12) Patent Application Publication
(10) Pub. No.: US 2008/0144109 A1
(43) Pub. Date: Jun. 19, 2008

(54) DATA PROCESSING SYSTEM AND METHOD THEREOF

(76) Inventor: Yu-Siang Chang, Taipei County (TW)

Correspondence Address: NORTH AMERICA INTELLECTUAL PROPERTY CORPORATION, P.O. BOX 506, MERRIFIELD, VA, 22116, US

(21) Appl. No.: 11/624,663

(22) Filed: Jan. 18, 2007

(30) Foreign Application Priority Data
Dec. 19, 2006 (TW) 095147677

(51) Int. Cl. G06K 15/00

(52) U.S. Cl. 358/2.1

(57) ABSTRACT

The present invention discloses a data processing system. The data processing system includes a data processing module and a printing module. The data processing module is utilized for receiving an input image data, and utilizing at least a scaling parameter to adjust a data corresponding to at least a specific color to generate a printing data that corresponds to the input image data. The printing module is coupled to the data processing module for receiving the printing data, and performing a printing operation with respect to the printing data.

### BACKGROUND OF THE INVENTION

1. Field of the Invention

The present invention provides a data processing system and method thereof, and more particularly, a data processing system utilized in a thermal autochrome printing apparatus and a related method.

2. Description of the Prior Art

Normally, when a printer performs an operation of printing different kinds of color strips, the dyes corresponding to the different kinds of color strips will have different respective tensions, resulting in the dye length of each of the color strips being different. Therefore the color strips of the image printed by the printer will not be printed exactly on a predetermined location of the image. For example, in a prior art thermal autochrome printer, there are four type of colors utilized for printing, which are yellow, magenta, cyan and black (YMCK), in which the dye of black color has more tension than the other three colors. Therefore, when the mechanism condition of the thermal autochrome printer is invariant, e.g. the temperature of the thermal autochrome process is the same, the image portion corresponding to the black color dye does not match the predetermined position exactly, and may extend to a wider region, as shown in FIG. 1. FIG. 1 is a diagram illustrating the unmatched region of the printing area 10 printed by the prior art thermal autochrome printer. According to the prior art as shown in FIG. 1, the tensions of the dyes of yellow, magenta, and cyan colors are almost the same, thus the dyes of yellow, magenta, and cyan colors will locate exactly in the predetermined areas 11, 12, 13 of the printed image. However, the dye of black color extends to the wider area of the predetermined area 14 (as shown by the dashed line), due to the dye of black color having a larger tension. When dyes do not correspond to the predetermined areas, mechanically adjusting the loading speed of the printing paper is one popular prior art method of solving the above-mentioned problem. The prior art method adjusts the speed of the rotating motor utilized for loading the printing paper, thereby adjusting the thermal autochrome time of the dye of black color. Accordingly, the spreading of the black color dye can be controlled, so it will not extend to other regions of the predetermined printing area. However, mechanically adjusting the loading speed of the printing paper is time consuming and it is difficult to obtain a precise result. Therefore, obtaining a more efficient and precise method for adjusting the extension of dyes is an important concern in this field.

### SUMMARY OF THE INVENTION

Therefore, one of the objectives of the present invention is to provide a data processing system and method thereof, to directly adjust the data corresponding to different color planes in the image data, which is processed by a printer, in order to precisely print the image color in the predetermined area, to solve the above-mentioned problem.

According to an embodiment of the present invention, a data processing system is disclosed. The data processing system comprises a data processing module and a printing module. The data processing module is utilized for receiving an input image data, and utilizing at least a scaling parameter to adjust a data that corresponds to at least a specific color to generate a printing data that corresponds to the input image data. The printing module is coupled to the data processing module for receiving the printing data, and performing a printing operation with respect to the printing data.

According to an embodiment of the present invention, a data processing method is disclosed. The data processing method comprises the steps of: receiving an input image data, and utilizing at least a scaling parameter to adjust a data that corresponds to at least a specific color to generate a printing data that corresponds to the input image data; and utilizing a printing module to receive the printing data, and perform a printing operation with respect to the printing data.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an unmatched region of a printing area printed by a prior art thermal autochrome printer.

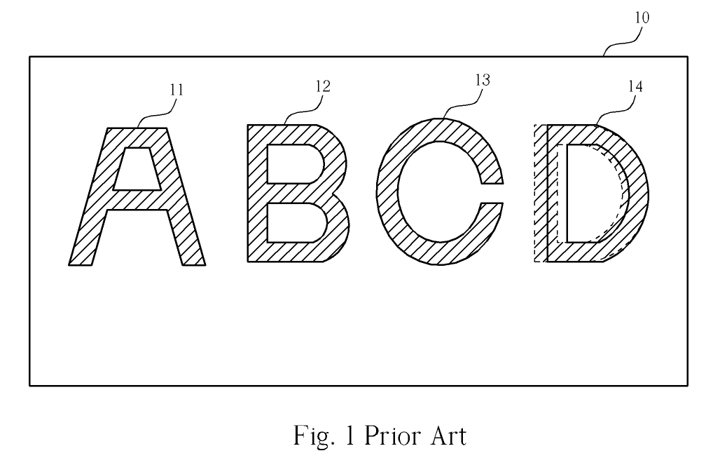

FIG. 2 is a diagram illustrating a data processing system according to a first embodiment of the present invention.

FIG. 3 is a diagram illustrating a printing area printed by the printing module as shown in FIG. 2.

FIG. 4 is a flow chart illustrating data processing of the data processing apparatus as shown in FIG. 2.

FIG. 5 is a diagram illustrating a data processing system according to a second embodiment of the present invention.

FIG. 6 is a flow chart illustrating data processing of the data processing apparatus as shown in FIG. 5.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

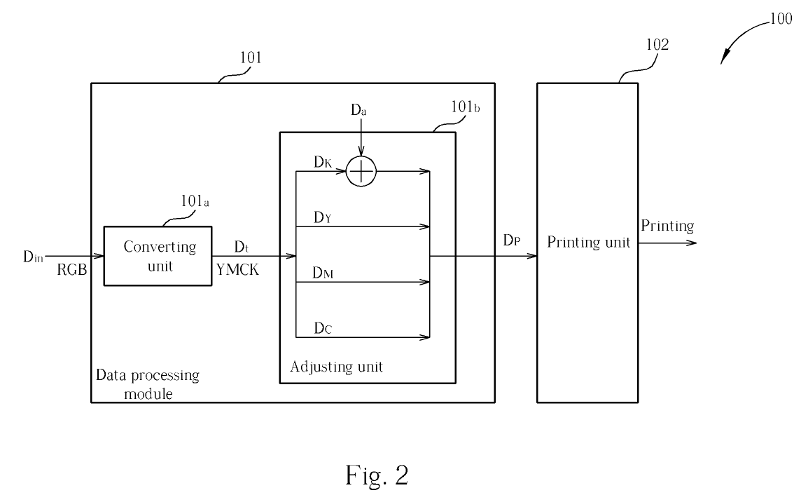

Please refer to FIG. 2. FIG. 2 is a diagram illustrating a data processing system 100 according to a first embodiment of the present invention. The data processing system 100 comprises a data processing module 101 and a printing module 102. The data processing module 101 is utilized for receiving an input image data Dᵢₙ, and utilizing at least a scaling parameter Dₐ to adjust a data that corresponds to at least a specific color (e.g. the data Dₖ that corresponds to the black color) to generate a printing data Dₚ that corresponds to the input image data Dᵢₙ; and the printing module 102 is coupled to the data processing module 101 for receiving the printing data Dₚ, and performing a printing operation with respect to the printing data Dₚ. In this embodiment, the data processing module 101 comprises a converting unit 101ₐ for converting the input image data Dᵢₙ from a first format into a second format according to a color plane utilized by the printing module 102 in order to generate a converted image signal Dₜ; and an adjusting unit 101_{b} coupled to the converting unit 101ₐ for receiving the converted image signal Dₜ, and adjusting the data corresponding to the specific color (e.g. black color) within the converted image signal Dₜ according to the scaling parameter Dₐ in order to generate the printing data Dₚ. Please note that, in order to describe the spirit of the present invention more clearly, in the data processing system 100 of the embodiment, the first format comprises red, green, and blue (RGB) colors; and the second format comprises yellow, magenta, cyan and black (YMCK) colors in the following description. Therefore, the color plane utilized by the printing module 102 also comprises yellow, magenta, cyan and black (YMCK) colors, and this is not a limitation of the present invention. In other words, the first format and the second format can be any other image format. The printing module 102 within the data processing system 100 of the embodiment is a thermal autochrome printing module, where the technique of the thermal autochrome printing module is well known by those skilled in this art, and therefore omitted here for brevity.

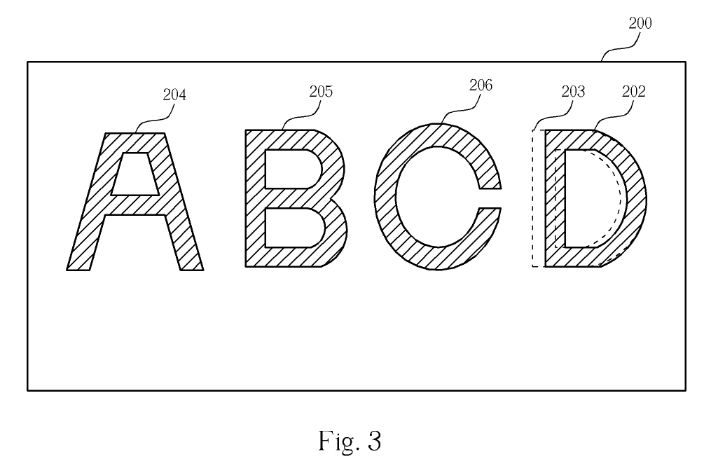

When the data processing module 101 receives the input image data Dᵢₙ of the first format that comprises red, green, and blue (RGB) colors, the converting unit 101a converts the input image data Dᵢₙ from the first format into the second format that comprises yellow, magenta, cyan and black (YMCK) colors, and outputs a converted image signal Dₜ, which comprises the data D_{Y}, D_{M}, D_{C}, D_{K} corresponding to the yellow, magenta, cyan and black colors respectively. This is because the printing module 102 of the embodiment can only accept and print the data of the second format that comprises yellow, magenta, cyan, and black colors. However, in the thermal autochrome printing module, the thermal autochrome conditions of each of the color planes are not totally the same when printing, in which the black color's thermal autochrome condition has the least similarity with the other colors. In other words, if the thermal autochrome condition of the printing module 102 is set to be equal for all colors when printing, then the black color will not be printed exactly on the predetermined region of the printed image. Therefore, the adjusting unit 101_{b} of the data processing module 101 adjusts the black color to be printed. In reality, the manufacturer first performs the print testing of the data processing system 100 to find out the deviation of the black color. Then, the scaling parameter Dₐ corresponding to the black color can be obtained. As finding out the scaling parameter Dₐ is well known by those skilled in this art, the detailed description is omitted here for brevity. Please refer to FIG. 3. FIG. 3 is a diagram illustrating a printing area 200 printed by the printing module 102 as shown in FIG. 2. The portion within the line format 202 of the printing area 200 is the region that should be filled by black color, and the dashed line 203, which represents the data D_{K} corresponding to the black color, is the thermal autochrome printing result before the adjustment. Therefore, the scaling parameter Dₐ can be installed within the adjusting unit 101b, and the adjusting unit 101b adjusts the data D_{K} corresponding to the black color within the converted image signal Dₜ according to the scaling parameter Dₐ whenever the thermal autochrome printing is performed. In this way, the output image that corresponds to the adjusted data Dₖₖ will then be located precisely in the predetermined region after the thermal autochrome printing performed by the printing module 102. The output image corresponding to the adjusted data Dₖₖ is the line format 202 as shown in FIG. 2. Please note that, in this embodiment, the yellow, magenta, and cyan colors that correspond to the image formats 204, 205, 206 respectively are not affected by the autochrome printing. In other words, in this embodiment, the data processing system 100 only adjusts the data D_{K} that corresponds to the black color, in order to stretch (or to shrink) the image dye of the data D_{K} corresponding to the black color when printing. However, please note that the present invention is not limited to adjusting the black color and adjusting the other colors (i.e. the data D_{y}, Dₘ, D_{c} that correspond to yellow, magenta, and cyan colors respectively) at the same time also belongs to the scope of the present invention. For example, in another embodiment, the data processing system 100 can also adjust the data D_{y}, Dₘ, D_{c} to stretch (or to shrink) the image dyes corresponding to yellow, magenta, and cyan colors respectively when printing.

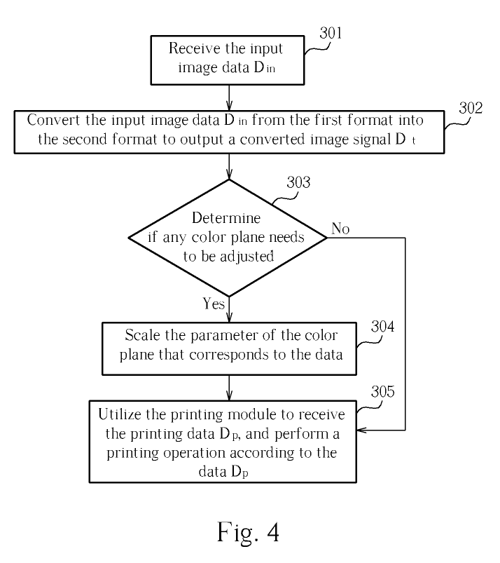

Please refer to FIG. 4. FIG. 4 is a flow chart illustrating the data processing of the data processing apparatus 100 as shown in FIG. 2. The method of the data processing applied in the data processing apparatus 100 comprises the following steps:

Step 301: Receive the input image data Dᵢₙ;

Step 302: Convert the input image data Dᵢₙ from the first format into the second format to output a converted image signal Dₜ, in which the first format comprises red, green, and blue (RGB) colors, and the second format comprises yellow, magenta, cyan and black (YMCK) colors, and output a converted image signal Dₜ;

Step 303: Determine if any color plane needs to be adjusted; if yes, go to step 304, if no, go to step 305;

Step 304: Scale the parameter of the color plane that corresponds to the data;

Step 305: Utilize the printing module 102 to receive the printing data Dₚ, and perform a printing operation according to the data Dₚ.

In step 303, as the data processing system 100 adjusts the data D_{K} corresponding to the black color, when it is determined that the data D_{K} corresponding to the black color needs to be adjusted, step 304 will utilize the scaling parameter Dₐ to adjust the data D_{K}. Then, the printing operation is performed in step 305, in which no adjustments are performed to the other colors (i.e. the data that correspond to the yellow, magenta, and cyan colors respectively) in step 305. Please note that the present invention is not limited to adjusting the black color and adjusting the other colors (i.e. the data D_{y}, Dₘ, D_{c} corresponding to yellow, magenta, and cyan colors respectively) at the same time also belongs to the scope of the present invention. Please note that, in step 302, the first format is not limited to the red, green, and blue (RGB) colors, and the second format is not limited to the yellow, magenta, cyan and black (YMCK) colors, in other words, the first format and the second format can be any other image format.

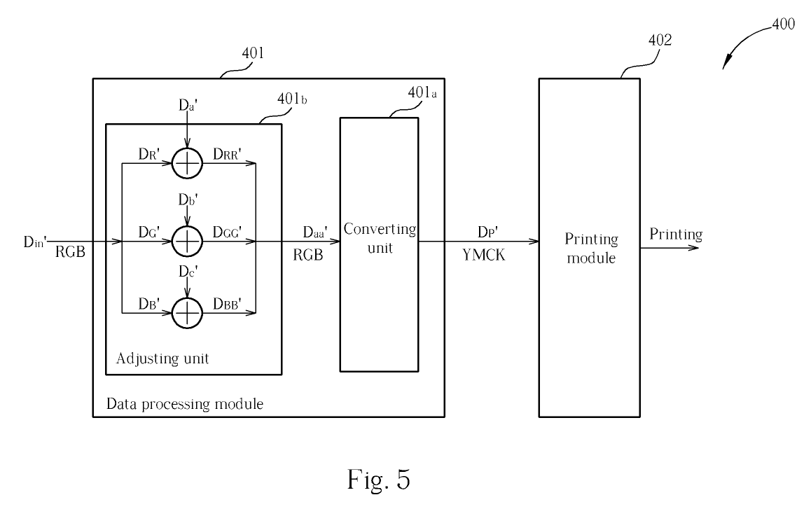

Please refer to FIG. 5. FIG. 5 is a diagram illustrating a data processing system 400 according to a second embodiment of the present invention. The data processing system 400 comprises a data processing module 401 and a printing module 402. The data processing module 401 is utilized for receiving an input image data Dᵢₙ′, and utilizing at least a scaling parameter to adjust a data that corresponds to at least a specific color (e.g. black color) to generate a printing data Dₚ′ that corresponds to the input image data Dᵢₙ′; where the printing module 402 is coupled to the data processing module 401 for receiving the printing data Dₚ′, and performing a printing operation with respect to the printing data Dₚ′. In this embodiment, the data processing module 401 comprises an converting unit 401ₐ for adjusting the data corresponding to the specific color (i.e. the black color) within the input image data Dᵢₙ′ according to a scaling parameter to generate an adjusted image signal Dₐₐ′; and a converting unit 401ₐ coupled to the adjusting unit 401_{b} for converting the adjusted image data Dₐₐ′ from a first format into a second format according to a color plane utilized by the printing module ‘402 to generate a printing data Dₚ’. Please note that, in order to describe the spirit of the present invention more clearly, in the data processing system 400 of the embodiment, the first format comprises red, green, and blue (RGB) colors; and the second format comprises yellow, magenta, cyan and black (YMCK) colors in the following description. Therefore, the color plane utilized by the printing module 402 also comprises yellow, magenta, cyan and black (YMCK) colors, and this is not a limitation of the present invention. In other words, the first format and the second format can be any other image format. The printing module 402 within the data processing system 400 of the embodiment is a thermal autochrome printing module, and as the technique of the thermal autochrome printing module is well known by those skilled in this art, it is omitted here for brevity.

Similar to the above-mentioned first embodiment, the thermal autochrome conditions of each of the color planes are not totally the same when printing, in which the black color has the most different thermal autochrome condition when compared to the other colors (i.e. yellow, magenta, and cyan colors). Therefore, if the thermal autochrome condition of the printing module 402 is set to be equal for all colors when printing, then the black color will not be printed exactly on the predetermined region of the printed image due to the above-mentioned reason.

When the data processing module 401 receives the input image data Dᵢₙ′ (i.e. the data D_{R}′, D_{G}′, D_{B}′ that correspond to red, green, blue colors respectively) of the first format that comprises the red, green, and blue (RGB) colors, the adjusting unit 401_{b} of the data processing module 401 adjusts the data to be printed, which corresponds to the black color, according to the scaling parameters Dₐ′, D_{b}′, D_{c}′ to generate the image data D_{RR}′, D_{GG}′, D_{BB}′, respectively. As obtaining the scaling parameters Dₐ′, D_{b}′, D_{c}′ is well known by those skilled in this art, the detailed description is omitted here for brevity. Then, the converting unit 401ₐ converts the adjusted image data Dₐₐ′ from the first format into the printing data Dₚ′ of the second format that comprises yellow, magenta, cyan and black (YMCK) colors. This is because the printing module 402 in the data processing apparatus 400 of the embodiment can only accept and print the data of the second format that comprises the yellow, magenta, cyan, and black colors. Therefore, when the printing module 402 prints the printing data Dₚ′ through the thermal autochrome, an ideal printing image can be obtained as shown in FIG. 3. Similar to the first embodiment, the scaling parameters Dₐ′, D_{b}′, D_{c}′ can be installed within the adjusting unit 401_{b}, and the adjusting unit 401_{b} adjusts the data that correspond to the black color within the input image signal Dᵢₙ′ according to the scaling parameter Dₐ′, D_{b}′, D_{c}′ whenever the thermal autochrome printing is performed. Therefore, the adjusted image data Dₐₐ′ after the format is converted will then be located precisely in the predetermined region after the thermal autochrome printing performed by the printing module 402. The output image that corresponds to the adjusted image data Dₐₐ′ is the line format 202 as shown in FIG. 2. In other words, in this embodiment, the data processing system 400 adjusts the input data input to the converting unit 401ₐ to reach the goal of adjusting the data (in the second format) corresponding to the black color. Please note that the present invention is not limited to adjusting the black color data of the second format and adjusting the other colors (i.e. the data corresponding to yellow, magenta, and cyan colors respectively) of the second format at the same time also belongs to the scope of the present invention.

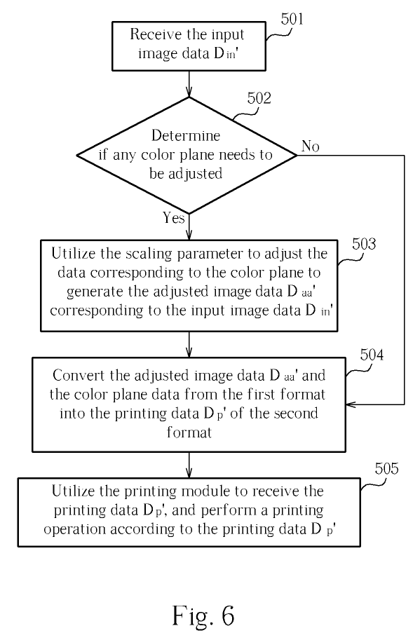

Please refer to FIG. 6. FIG. 6 is a flow chart illustrating the data processing of the data processing apparatus 400 as shown in FIG. 5. The method of the data processing applied in the data processing apparatus 400 comprises the following steps:

Step 501: Receive the input image data Dᵢₙ′;

Step 502: Determine if any color plane needs to be adjusted; if yes, go to step 503, if no, go to step 504;

Step 503: Utilize the scaling parameter to adjust the data corresponding to the color plane to generate the adjusted image data Dₐₐ′ corresponding to the input image data Dᵢₙ′;

Step 504: Convert the adjusted image data Dₐₐ′ and the color plane data from the first format into the printing data Dₚ′ of the second format, in which the first format comprises red, green, and blue (RGB) colors, and the second format comprises yellow, magenta, cyan and black (YMCK) colors;

Step 505: Utilize the printing module 402 to receive the printing data Dₚ′, and perform a printing operation according to the printing data Dₚ′.

In step 502, as the data processing system 400 adjusts the data corresponding to the black color of the second format, when it is determined that the data that corresponds to the black color needs to be adjusted, the step 503 will utilize the scaling parameters Dₐ′, D_{b}′, D_{c}′ to adjust the related data of the input image data Dᵢₙ′. Furthermore, obtaining the scaling parameters Dₐ′, D_{b}′, D_{c}′ is well known by those skilled in this art, thus the detailed description is omitted here for brevity. Please note that the present invention is not limited in adjusting the black color and adjusting the other colors of the second format (i.e. the data D_{y}, Dₘ, D_{c} corresponding to yellow, magenta, and cyan colors respectively) at the same time also belongs to the scope of the present invention.

In the above-mentioned embodiments, the data processing systems 100, 400 as shown in FIG. 2 and FIG. 5 respectively are installed in the printer, in which the printer comprises the data processing modules 101, 401 for actively setting the scaling parameters to adjust the printed output image, but this is not a limitation of the present invention. In other embodiments, the printing modules 102, 402 are installed in a computer externally connected to the printer, and the data processing modules 101, 401 are executed by the computer. For example, the computer provides a user interface for the user, where the user adjusts the input image data (as shown in FIG. 5) or the converted image data (as shown in FIG. 2) through the user interface according to user requirements. Furthermore, the adjusted image data is transmitted to the printing module for performing the printing operation. In other words, the user utilizes a firmware of the printing module to set the scaling parameters, and then the computer (i.e. the data processing modules 101, 401) outputs the required printing data.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A data processing system, comprising:
a data processing module, for receiving an input image data, and utilizing at least a scaling parameter to adjust a data corresponding to at least a specific color to generate a printing data that corresponds to the input image data; and
a printing module, coupled to the data processing module, for receiving the printing data, and performing a printing operation with respect to the printing data.

2. The data processing system of claim 1, wherein the data processing module comprises:
a converting unit, for converting the input image data from a first format into a second format according to a color plane utilized by the printing module to generate a converted image signal; and
an adjusting unit, coupled to the converting unit, for receiving the converted image signal, and adjusting the data corresponding to the specific color within the converted image signal according to the scaling parameter to generate the printing data.

3. The data processing system of claim 2, wherein the first format is a format comprising red, green, and blue colors (RGB).

4. The data processing system of claim 3, wherein the second format is a format that comprises yellow, magenta, cyan and black colors (YMCK).

5. The data processing system of claim 2, wherein the second format is a format that comprises yellow, magenta, cyan and black colors (YMCK).

6. The data processing system of claim 1, wherein the data processing module comprises:
an adjusting unit, for adjusting the data corresponding to the specific color within the input image data according to the scaling parameter to generate an adjusted image data;
a converting unit, coupled to the adjusting unit, for converting the adjusted image data from a first format into a second format according to a color plane utilized by the printing module to generate the printing data.

7. The data processing system of claim 6, wherein the first format is a format comprising red, green, and blue colors (RGB).

8. The data processing system of claim 7, wherein the second format is a format that comprises yellow, magenta, cyan and black colors (YMCK).

9. The data processing system of claim 6, wherein the second format is a format that comprises yellow, magenta, cyan and black colors (YMCK).

10. The data processing system of claim 1, wherein the data processing module utilizes the scaling parameter to adjust data that corresponds to a plurality of specific colors.

11. The data processing system of claim 1, being a printer.

12. The data processing system of claim 1, wherein the data processing module is a computer host, for setting the scaling parameter according to a driver of the printing module to generate the printing data with respect to the input image data.

13. A data processing method, comprising:
(a) receiving an input image data, and utilizing at least a scaling parameter to adjust a data corresponding to at least a specific color to generate a printing data that corresponds to the input image data; and
(b) utilizing a printing module to receive the printing data and perform a printing operation with respect to the printing data.

14. The data processing method of claim 13, wherein the step (a) comprises:
converting the input image data from a first format to a second format according to a color plane utilized by the printing module to generate a converted image signal; and
receiving the converted image signal, and adjusting the data corresponding to the specific color within the converted image signal according to the scaling parameter to generate the printing data.

15. The data processing method of claim 14, wherein the first format is a format comprising red, green, and blue colors (RGB).

16. The data processing method of claim 15, wherein the second format is a format that comprises yellow, magenta, cyan and black colors (YMCK).

17. The data processing method of claim 14, wherein the second format is a format that comprises yellow, magenta, cyan and black colors (YMCK).

18. The data processing method of claim 13, wherein the step (a) comprises:
adjusting the data corresponding to the specific color within the input image data according to the scaling parameter to generate an adjusted image data; and
converting the adjusted image data from a first format into a second format according to a color plane utilized by the printing module to generate the printing data.

19. The data processing method of claim 18, wherein the first format is a format comprising red, green, and blue colors (RGB).

20. The data processing method of claim 19, wherein the second format is a format that comprises yellow, magenta, cyan and black colors (YMCK).

21. The data processing method of claim 18, wherein the second format is a format that comprises yellow, magenta, cyan and black colors (YMCK).

22. The data processing method of claim 13, wherein the step (a) utilizes the scaling parameter to adjust data that corresponds to a plurality of specific colors.

23. The data processing method of claim 13, wherein the step (a) is performed in a printer.

24. The data processing method of claim 13, wherein the step (a) is executed by a computer host, and the computer host sets the scaling parameter according to a driver of the printing module to generate the printing data with respect to the input image data.
